(19) United States
(12) Patent Application Publication
(10) Pub. No.: US 2012/0225409 A1
(43) Pub. Date: Sep. 6, 2012

(54) Method For Producing Individual Drilling Templates For Dental Implant Surgery In A Patient's Jawbone

(76) Inventor: Karsten Baumann, Keltern (DE)

(21) Appl. No.: 13/290,112

(22) Filed: Nov. 6, 2011

(30) Foreign Application Priority Data
Mar. 3, 2011 (DE) DE 102011013191.4

(51) Int. Cl. A61C 13/38

(52) U.S. Cl. 433/214

(57) ABSTRACT

A method for producing an individualized drilling template for dental implant surgery in a patient's jawbone is disclosed. The clinical user (dentist or dental technician) is provided with a transfer template with the aid of which the drilling template can be made on-site. The process is intended for use in dentistry.

### RELATED APPLICATION

This application claims priority from the German Patent Application DE 102011013191.4, which was filed on Mar. 3, 2011. That application is incorporated herein by reference as if set out in full.

### BACKGROUND

1. Field of the Invention

The present invention relates to dental implant surgery, and more specifically to a process for producing an individualized drilling template for dental implant surgery in a patient's jawbone.

2. Background of the Invention

Dental implant surgery is used to restore lost teeth to a patient. Restoration is performed by drilling a hole in the jawbone of the patient at the position of the missing tooth, and then fixing an implant in the hole. The implant is thereby fixed to the jaw bone and it is this implant which is configured to accept a prosthetic tooth or teeth.

Generally, dental implant surgery comprises several steps. These steps typically comprise: making an imprint of the patient's teeth and gums, making a plaster model of the patient's jaw from the imprint, making a tomographic scan of the jaws of the patient while the patient wears a temporary prosthesis, planning the position and orientation of the dental implant or implants using software, ordering the implants and a surgical guide, drilling holes in the patient's jaw using the surgical guide and installing the implants, allowing a healing period, and ordering and installing the prosthesis.

One drawback of this process is that generally several of these steps are completed by an off-site lab. In particular, generally the dentist has an off-site lab make the plaster model of the patient's jaw, plan the position and orientation of the dental implants, and make the surgical guide. This increases both the cost and the amount of time required for the dental implant surgery process.

It is thus a first object of the present invention to provide a process by which an individual dentist may produce an individualized drilling template for dental implant surgery in a patient's jawbone quickly, easily, and accurately.

It is a second object of the present invention to provide a process by which an individual dentist may produce an individualized drilling template for dental implant surgery entirely in-house.

These and other objects, advantages, features, and aspects of the present invention will become apparent as the following description proceeds. To the accomplishment of the foregoing and related ends, the invention, then, comprises the features hereinafter more fully described and particularly pointed out in the claims, the following description and the annexed drawings setting forth in detail certain illustrative embodiments of the invention, these being indicative, however, of but several of the various ways in which the principles of the invention may be employed.

### SUMMARY OF THE INVENTION

The present application presents a method for producing individual drilling templates for dental implant surgery in a patient's jawbone. The present application draws on several methods and technologies known in the art, and extends them in a novel way.

It is known in the art (see for example EP0756735A1, based on PCT/BE95/00033) to make medical models of body parts based on digital image capture and rapid prototyping. These models can also incorporate an artificial functional element, such as a drill bit guide. Furthermore, the digital image data of the artificial functional element can be made available in a form that permits a digital construction. It is also known in the art to modify digital image data in preparation for surgery. For example, the position and axial orientation of a dental implant can be determined on-screen, or surgical techniques can be simulated.

The present application presents a method to extend these known methods in such a way as to allow clinical users to make their own drilling templates by transferring a provided mechanical transfer template that can be precisely linked with the drilling template. Using this method a drilling template can be made on-site.

### BRIEF DESCRIPTION OF THE DRAWINGS

The foregoing aspects and many of the attendant advantages of the invention will become more readily appreciated as the same becomes better understood by reference to the following detailed description, when taken in conjunction with the attached charts and figures, wherein:

FIG. 1 is a side view of an orthodontic model (plaster or synthetic material-based dental cast);

FIG. 2 is a side view of an orthodontic model during production of a deep-drawing splint;

FIG. 3 is a side view of a bite plate joined to a deep-drawing splint;

FIG. 4 is a representative view of a patient receiving a CT/CBCT scan while wearing a temporary prosthesis;

FIG. 5 is a representative view of using a processing unit to: Plan the implant using specially configured planning software; Export the planned implant data from the planning software; and import the planning data into a laboratory software;

FIG. 6 is a side view of excavating a frame cavity for the planned implant with tools.

FIG. 7 shows two side views of the positioning guide, the upper part of the drawing shows an exploded drawing of the positioning guide, while the lower part shows the assembly of the individual components of the guide on the transfer template;

FIG. 8 is a side view of fitting the transfer template onto the bite plate;

FIG. 9 is a side view of checking the free space;

FIG. 10 is a side view of reversing the assembled unit and casting the drill sleeve with a casting compound;

FIG. 11 is a side view of the integral drill sleeve after casting;

FIG. 12 is a side view of removing the positioning guide;

FIG. 13 is a side view of removing the transfer template;

FIG. 14 is a side view of removing the bite plate; and

FIG. 15 is a side view of the finished drilling template.

### DETAILED DESCRIPTION OF THE INVENTION

The following description is presented to enable a person of ordinary skill in the art to make and use various aspects and examples of the present invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

The present application presents a method for producing individual drilling templates for dental implant surgery in a patient's jawbone. In the preferred embodiment the method disclosed by the present application allows a drilling template to be made entirely on-site and employs computer programs in addition to physical manipulation steps.

Turning first to FIG. 1, the first step in the method of creating a drilling template for drilling receiving holes for dental implants is shown. In this step the dentist or dental technician makes a dental cast/orthodontic model 1 of the patient's jaw in plaster or synthetic material. As shown in FIG. 1, the orthodontic model 1 in our example exhibits an edentulous space 2, which will eventually be filled with the dental implant and prosthesis.

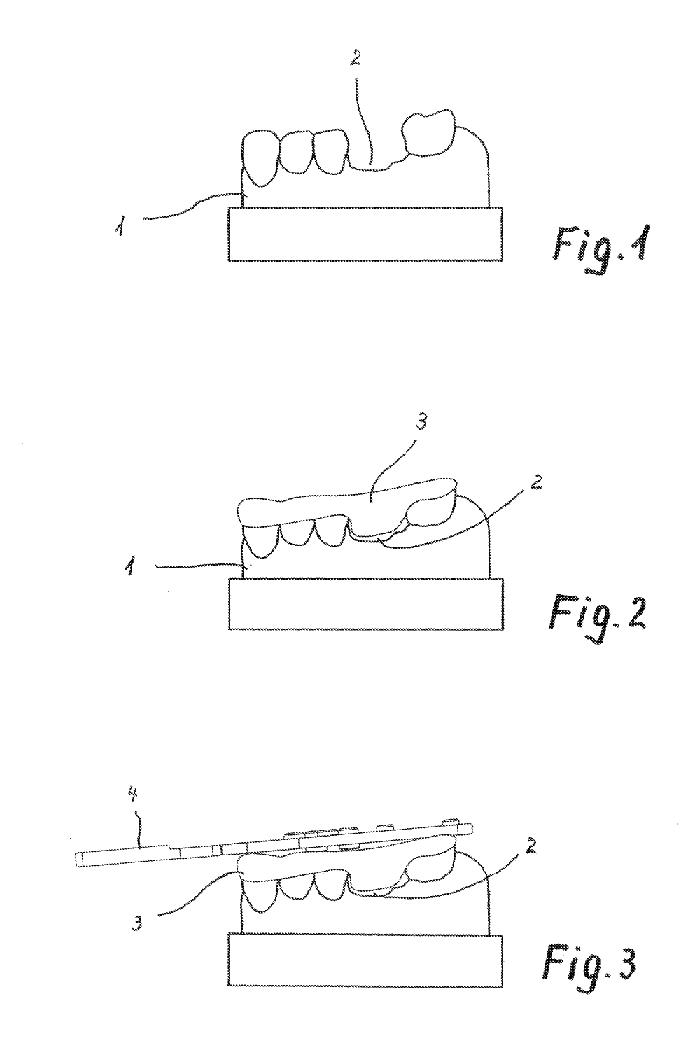

Turning to FIG. 2, the next step in the method is to attach a deep-drawing splint 3 is to the orthodontic model 1, in which the edentulous space 2 is filled up by the deep-drawing scanning splint 3.

Turning to FIG. 3, the next step in the method is to attach a bite plate 4 to the deep-drawing scanning splint 3 by adhesive or polymer bonding.

Turning to FIG. 4, the next step in the method is to conduct a CT/CBT scan of the patient with the bite plate 4 in place in the patient's mouth. This step is represented here symbolically as CT/CBCT scan 5.

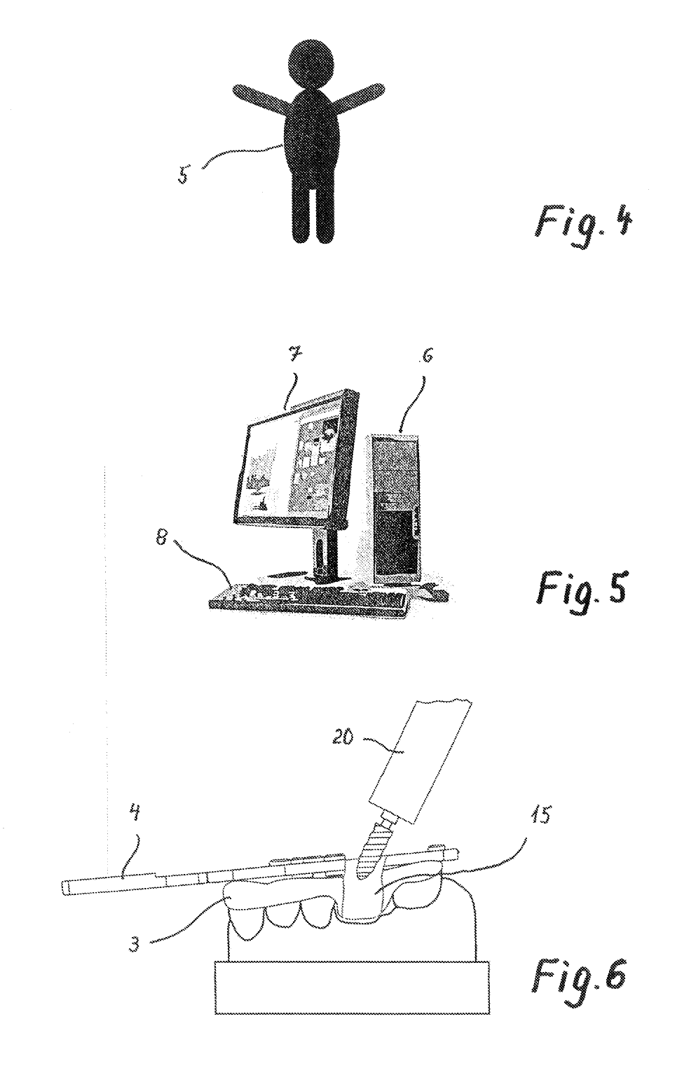

Turning to FIG. 5, the next step in the method is accomplished with a computer 6 which is shown here with monitor 7 and keyboard 8, and which contains a memory which contains computer instruction code (i.e. software) configured to accomplish the following: segmenting the data record obtained and calculating a 3D solid model; planning the dental implant; determining the required configuration of the positioning guide 16 and transfer template 10.

The computer instruction code is preferably additionally configured to import patient data (DICOM-standard) which usually comes from a CT or Cone Beam Scanner and to import 3D data which usually comes from a high-resolution 3D-surface scanner. One of the main features of the computer instruction code is the calibration (matching the markers) of reference markers which are located inside the bite-plate with virtual reference markers in the software. This process is necessary to calibrate the reference position for the drilling sequence of the transfer template. The computer instruction code also preferably drives a drilling device (CNC milling machine).

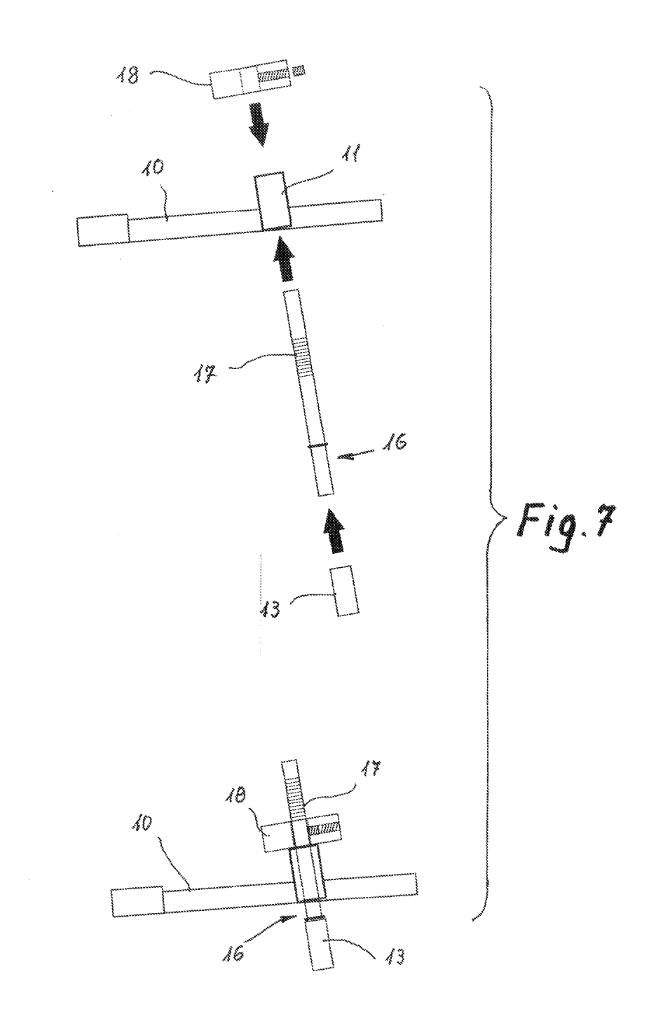

Turning to FIG. 6, the next step in the method is to excavate a frame cavity 15 in the intended area of the implant in the deep-drawing splint 3 with the aid of standard tools 20. It is within this frame cavity 15 that the integral drill sleeve 13 will be cast.

Turning to FIG. 7, two side views of the positioning guide 16 of a preferred embodiment are shown, the upper part of the drawing shows an exploded view of the positioning guide, which illustrates the individual components of the guide, while the lower part shows the assembly of the individual components of the guide on the transfer template. In a preferred embodiment the positioning guide 16 is a pin-type positioning guide with a readable scale 17 and adjustable retaining ring 18 on one side, and a mounted drill sleeve 13 on the other. In a preferred embodiment the positioning guide 16 is assembled using the transfer template 10 which has a guide sleeve 11. This assembly provides positioning control over the depth of the drill sleeve 13 and mounting of individual components. In an alternative embodiment the adjustable retaining ring 18 may be omitted.

In a preferred embodiment, the user can adjust a scale on the positioning guide to control the depth of the drill sleeve(s). Generally, this adjustment is based on specified depth control data from the software.

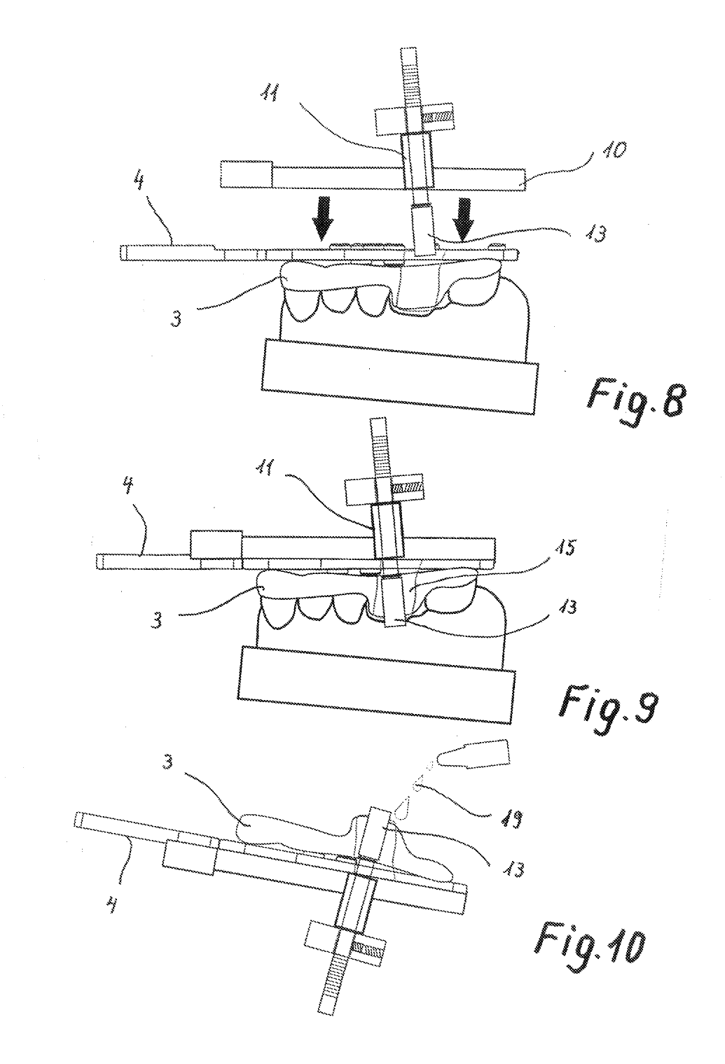

Turning to FIG. 8, the next step in the method is to fit the assembled transfer template 10 and positioning guide 16 onto the bite plate 4. FIG. 8 shows a preferred embodiment in which the guide sleeve 11 is present. In an alternative embodiment the guide sleeve 11 may be omitted.

Turning to FIG. 9, the next step in the method is to size check the frame cavity 15 in the deep-drawing splint 3. The fit of the transfer template 10 should be tension-free. The correct setting of the depth of the drill sleeve 13 is checked, as well as whether there remains sufficient space for filling the frame cavity 15 with casting compound 19 (see FIG. 10).

Turning to FIG. 10, the next step is to remove the unit comprising the transfer template 10, bite plate 4, and deep-drawing splint 3 from the model 1 and to turn it upside down. In this position the drill sleeve 13 is cast in place using a casting compound 19.

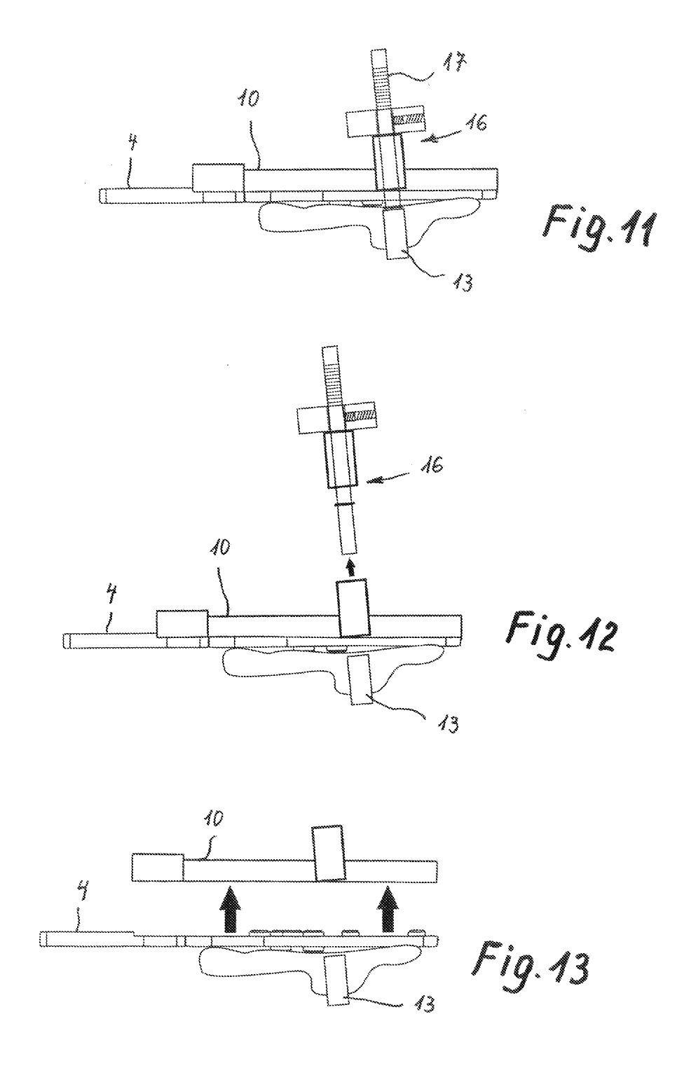

Turning to FIG. 11, the next step is to allow the casting compound to dry/set and to turn the entire unit right side up.

Turning to FIG. 12, the next step is to remove the positioning guide 16 from the transfer template 10 and the bite plate 4.

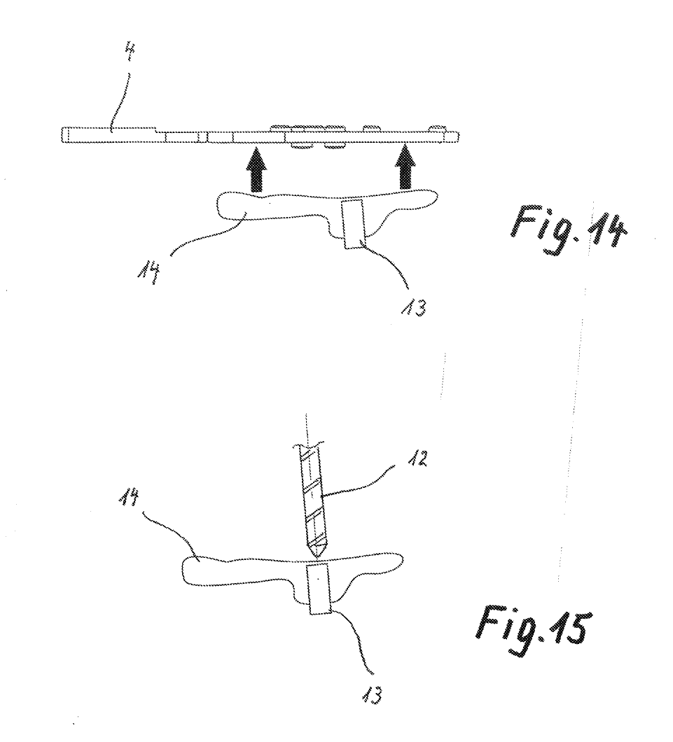

Turning to FIG. 13, the next step is to remove the transfer template 10 from the bite plate 4.

Turning to FIG. 14, the next step is to remove the bite plate 4 from what was the deep-drawing splint 3, and is now the drilling template 14.

Turning to FIG. 15, having completed all the steps of the method, the finished drilling template 14 is ready to use.

This drilling template allows dental surgeons to drill the anchoring holes for the planned implants easily and accurately.

In an alternative embodiment a CNC milling machine is employed for transferring the implant position(s) (i.e. holes) onto the transfer template. In this alternative embodiment no drill sleeve is employed, and the positioning guide is placed directly through the CNC created hole in the transfer template. The precise fit of the transfer template drill hole(s) provides the necessary friction to prevent the guide from inadvertently sliding out or otherwise moving relative to the transfer template.

Although the invention has been shown and described with respect to certain embodiments, it is obvious that equivalent alterations and modifications will occur to others skilled in the art upon the reading and understanding of the specification. In particular, with regard to the various functions performed by the above-described components, the terms (including any reference to a “means”) used to describe such components are intended to correspond, unless otherwise indicated, to any component which performs the specified function of the described component (e.g., that is functionally equivalent) even though not structurally equivalent to the disclosed component which performs the functions in the herein exemplary embodiments of the invention. In addition, while a particular feature of the invention may have been disclosed with respect to only one embodiment, such feature may be combined with one or more other features of other embodiments as may be desired or advantageous for any given or particular application.

I claim:

1. A method for making a drilling template for dental implant surgery in a patient's jawbone, the method comprising:
a. making an orthodontic model of a patient's jaw;
b. making a deep-drawing splint based the orthodontic model, wherein said splint fills-in any edentulous spaces in said model;
c. connecting a scanning bite plate to said deep-drawing splint;
d. scanning said patient with a CT/CBCT machine with said bite plate in place in said patient's mouth;
e. segmenting a data record obtained from said scanning step and calculating a 3D solid model;
f. planning a dental implant in a planning software including the step of determining the required position and axial orientation of one or more implant holes;
g. based on said planning step, boring appropriate holes in a transfer template and attaching to said transfer template a positioning guide to which a drill sleeve is attached;
h. excavating a frame cavity for said implant in said deep-drawing splint;
i. fitting said transfer template with positioning guide and attached drill sleeve onto said bite plate;
j. checking that the size of said frame cavity is adequate;
k. casting said drill sleeve into said deep-drawing splint;
l. removing said positioning guide; and
m. removing said transfer template.

2. The method according to claim 1, further comprising inserting an additional cylindrical guide sleeve for the positioning guide into said transfer template.

3. The method according to claim 2 further comprising using one or more centering and coupling elements to achieve a more precise fit between said transfer template and said deep-drawing splint.

4. The method according to claim 1 further comprising using one or more centering and coupling elements to achieve a more precise fit between said transfer template and said deep-drawing splint.

5. The method according to claim 1 wherein said bite plate is made of synthetic materials.

6. The method according to claim 1 wherein said bite plate is made of sterilizable synthetic materials.

7. A method for making a drilling template comprising:
a. providing a deep-drawing splint which fills-in any edentulous spaces in an orthodontic model of a patient's jaw;
b. scanning said patient with a CT/CBCT machine with said deep-drawing splint in place in said patient's mouth;
c. creating a 3D model;
d. determining the required position and axial orientation of at least one implant hole;
e. based on said determining step, boring appropriate holes in a transfer template and attaching to said transfer template at least one positioning guide to which a drill sleeve is attached;
f. excavating a cavity for said implant in said deep-drawing splint;
g. fitting said transfer template and said at least one positioning guide and attached drill sleeve onto said deep-drawing splint;
h. casting said drill sleeve into said deep-drawing splint;
i. removing said positioning guide; and
j. removing said transfer template.

8. The method according to claim 7, further comprising inserting an additional cylindrical guide sleeve for the positioning guide into said transfer template.

9. The method according to claim 8 further comprising using one or more centering and coupling elements to achieve a more precise fit between said transfer template and said deep-drawing splint.

10. The method according to claim 7 further comprising using one or more centering and coupling elements to achieve a more precise fit between said transfer template and said deep-drawing splint.

11. The method according to claim 7 wherein said bite plate is made of synthetic materials.

12. The method according to claim 7 wherein said bite plate is made of sterilizable synthetic materials.
